(19) United States
(12) Patent Application Publication
(10) Pub. No.: US 2026/0029091 A1
(43) Pub. Date: Jan. 29, 2026

(54) DEVICE AND METHOD FOR FILLING A PRESSURIZED-GAS TANK

(71) Applicant: L'Air Liquide, Societe Anonyme pour l'Etude et l’Exploitation des Procedes Georges Claude, Paris (FR)

(72) Inventors: Arnaud CHAROLAIS, Jouy-En-Josas (FR); Fouad AMMOURI, Jouy-En-Josas (FR); Etienne WERLEN, Paris (FR); Hanane BOURAS, Jouy-En-Josas (FR); Elena VYAZMINA, Jouy-En-Josas (FR)

(21) Appl. No.: 18/995,229

(22) PCT Filed: Jul. 7, 2023
(86) PCT No.: PCT/EP2023/068922

§ 371 Date: Jan. 16, 2025

(30) Foreign Application Priority Data
Jul. 20, 2022 (FR) FR 2207428

(51) Int. Cl. F17C 5/00

(52) U.S. Cl. CPC F17C 5/007; F17C 2205/0326; F17C 2205/0352; F17C 2221/012; F17C 2250/032; F17C 2250/043; F17C 2250/0439; F17C 2250/0626; F17C 2250/0636; F17C 2250/0694; F17C 2270/0168; F17C 2270/0184

(57) ABSTRACT

The invention relates to a method for filling a pressurized-gas tank by means of a filling device comprising a gas source, a filling pipe connecting the source to the tank, a flow-rate and/or pressure control valve, an electronic control member configured to bring filling to a stop when an estimated temperature of the gas present in the tank reaches a temperature limit value, the method comprising, prior to the tank being filled, a step of determining the ambient temperature at the filling device, a step of determining the pressure of the gas present in the tank and a preliminary step of estimating the initial temperature of the gas present in the tank, the initial temperature of the gas present in the tank being a value estimated on the basis of the ambient temperature and on the basis of the pressure of the gas present in the tank prior to the tank being filled, the initial temperature of the gas present in the tank being higher than or equal to or lower than or equal to the ambient temperature.

### CROSS REFERENCE TO RELATED APPLICATIONS

This application is a § 371 of International PCT Application PCT/EP2023/068922, filed Jul. 7, 2023, which claims the benefit of FR2207428, filed Jul. 20, 2022, both of which are herein incorporated by reference in their entireties.

### FIELD OF THE INVENTION

The invention relates to a device and a method for filling a pressurized-gas tank.

The invention is particularly applicable to filling hydrogen tanks.

### BACKGROUND OF THE INVENTION

In a device as described above, the temperature of the gas present in the tank, and in particular the temperature before filling, is still difficult to acquire. In a known manner, the initial temperature used in the existing filling protocols is derived from the SAE (“Society of Automotive Engineering”) recommendations relating to filling fuel cell vehicles. The initial temperature is provided as a function of the ambient temperature according to a predefined curve for the hot case and a predefined curve for the cold case.

However, in practice it has been shown that the initial temperature of the tank to be filled does not always change according to these curves recommended by the SAE. Thus, with an initial temperature of the tank that is outside the corridor formed by the curves recommended by the SAE, the tank is notably exposed to a risk of overheating or overfilling.

The risk of overheating increases in the event of successive fillings. Indeed, while filling generally leads to an increase in temperature of the gas present in the tank, current protocols consider that, for a subsequent filling, the initial temperature of the tank remains within the corridor defined by the SAE. Thus, due to an initial temperature of the gas that is under-estimated during the subsequent filling, the temperature limit can be exceeded quickly, contrary to the predictions of the models deployed in the current filling protocols.

An aim of the present invention is to overcome all or some of the aforementioned disadvantages of the prior art.

### SUMMARY OF THE INVENTION

In certain embodiments, the invention relates to a device for filling a pressurized-gas tank, the device comprising: a gas source, a filling pipe connecting the source to the tank, a flow rate and/or pressure control valve in the filling pipe, a sensor configured to measure the pressure in the tank and/or the ambient temperature on the filling device, and an electronic control component configured to: stop filling when an estimated temperature (respectively, a density) of the gas present in the tank reaches a temperature limit value (respectively, a density limit value); and estimate, before filling the tank, an initial temperature of the gas present in the tank.

In an effort to overcome the deficiencies of the prior art discussed, supra, the device according to certain embodiments of the invention, moreover in accordance with the generic definition provided in the above preamble, is configured such that the initial temperature is a value that is estimated as a function of the ambient temperature and as a function of the pressure of the gas present in the tank before filling, with the initial temperature of the gas in the tank being greater than or equal to or less than or equal to the ambient temperature.

Thus, the invention improves the accuracy with which the initial temperature of the gas present in the tank is estimated, thus limiting the risk of overheating or overfilling of the tank.

In certain embodiments, the invention also relates to a method for filling a pressurized-gas tank, implemented by a filling device comprising a gas source, a filling pipe connecting the source to the tank, a flow rate and/or pressure control valve in the filling pipe, and an electronic control component configured to stop filling when an estimated temperature (or density) of the gas present in the tank reaches a temperature limit value (or, respectively, a density limit value). The method comprises, before filling the tank, a step of determining the ambient temperature on the filling device, a step of determining the pressure of the gas present in the tank and a preliminary step of estimating the initial temperature of the gas present in the tank. The initial temperature of the gas in the tank is a value that is estimated as a function of the ambient temperature and as a function of the pressure of the gas present in the tank before filling, with said initial temperature of the gas in the tank being greater than or equal to or less than or equal to the ambient temperature.

Furthermore, embodiments of the method according to the invention can comprise one or more of the following features:
the initial temperature of the gas in the tank is divided into a first computed initial temperature corresponding to a state of the tank that is considered to be recently filled to a first initial density, and a second computed initial temperature corresponding to a state of the tank that is considered to be recently drawn off to a second initial density;
the first initial temperature of the gas present in the tank is within a high temperature range with a lower limit that is determined to be greater than or equal to the ambient temperature and an upper limit corresponding to a determined maximum temperature limit, for example, equal to 85° C.;
the first initial temperature is determined from a first predetermined predictive curve “TPgas_hot” provided by a predetermined physical model simulating a reference filling of the tank over the high temperature range;
the second initial temperature of the gas present in the tank is within a low temperature range with an upper limit that is determined to be less than or equal to the ambient temperature and a lower limit corresponding to a determined minimum temperature limit, for example, ranging between zero and −5° C.;
the second initial temperature is determined from a second predetermined predictive curve “TPgas_cold” provided by a predetermined physical model simulating a reference draining of the tank over the low temperature range;
the method comprises a step of modeling, during filling, a first temperature variation curve (or, respectively, a first density variation curve) of the gas present in the tank, having the first initial temperature (respectively, the first initial density) of the gas present in the tank as the starting condition, and/or a second temperature variation curve (respectively, a second density variation curve) of the gas present in the tank, having the second initial temperature (respectively, the second initial density) of the gas present in the tank as the starting condition;
the method comprises a step of estimating, during filling, a temperature variation curve (or, respectively, a density variation curve) of the gas present in the tank, with said curve ranging between the first temperature variation curve (respectively, the first density variation curve) and the second temperature variation curve (respectively, the second density variation curve);—the first initial temperature and/or the second initial temperature of the tank is recomputed during filling as a function of the flow rate and as a function of the temperature of the gas present in the filling pipe, with said flow rate and said temperature being determined by computation and/or by sensors on the filling device;
the temperature limit value (respectively, the density limit value) is a determined fixed value, for example, 85° C. (respectively, for example, 24.1 kg/m3 or 40.2 kg/m3) or a value provided by a reference temperature curve “TPgas_max” (respectively, by a reference density curve “RHO_cold”), with said curve being provided by a predetermined physical model that simulates the thermodynamic conditions of the gas during a reference filling of the tank;
the physical model is based on a system of equations comprising at least one from among:
   an internal energy balance equation applied to the gas present in the tank;
   a mass balance equation applied to the gas present in the tank;
   an energy conservation equation in a tank wall;
   a heat flow continuity equation between the gas present in the tank and the tank wall;
   a heat flow continuity equation between the tank wall and the ambient air; and
   a flow rate equation connecting a mass flow rate of the filling device to a pressure difference between the filling device and the tank;
the first initial temperature (respectively, the second initial temperature) of the tank and the initial pressure of the gas present in the tank are obtained by solving said system of equations, for example, using a tridiagonal matrix type algorithm;
the ambient temperature of the filling device and the initial pressure of the gas present in the tank are determined by computation and/or are measured by sensors on the filling device;
the electronic control component is configured to control the flow rate and/or pressure control valve in order to generate a predetermined pressure curve or ramp during filling;
the electronic control component is configured to simulate and estimate the density variation curve (and/or the temperature variation curve) of the gas present in the tank in a dynamic manner when filling the tank and/or in an anticipated manner, i.e., before filling.

The invention can also relate to any alternative device or method comprising any combination of the features described above or hereafter within the scope of the claims.

### BRIEF DESCRIPTION OF THE DRAWINGS

These and other features, aspects, and advantages of the present invention will become better understood with regard to the following description, claims, and accompanying drawings. It is to be noted, however, that the drawings illustrate only several embodiments of the invention and are therefore not to be considered limiting of the invention's scope as it can admit to other equally effective embodiments.

Further particular features and advantages will become apparent upon reading the following description, which is provided with reference to the figures, in which:

FIG. 1 schematically and partially illustrates a filling device according to the invention;

FIG. 2 schematically illustrates steps of a filling method by means of the filling device;

FIG. 3 illustrates a reference temperature curve providing, for a given ambient temperature, a change in the temperature limit of the gas as a function of its pressure;

FIG. 4 illustrates a change in relation to the ambient temperature of a lower limit (respectively, of an upper limit) associated with a high temperature range (respectively, a low temperature range) in which a reference filling occurs;

FIG. 5 illustrates curves providing, for a simulated reference filling at a given ambient temperature, the variation in the temperature of the tank that is considered to be recently filled (respectively, that is considered to have been recently drawn off), the variation in the temperature, the density and the pressure of the gas present in said tank, the variation in the temperature and the pressure of the gas at the outlet of the filling device;

FIG. 6 illustrates a surface curve corresponding to several reference temperature curves established for various ambient temperatures;

FIG. 7 illustrates the reference temperature curve of FIG. 1 with a reduced “temperature” variable between 0 (zero) and 1 (one);

FIG. 8 illustrates reference temperature curves and predictive curves of the first initial temperature of the tank or of the gas present in said tank;

FIG. 9 illustrates curves representing a change in the temperature of the tank and in the temperature of the gas present in said tank, with said change being linked to a thermal diffusion after a reference filling;

FIG. 10 illustrates the curves of FIG. 8 after reducing the “temperature” variable;

FIG. 11 illustrates predictive curves of the second initial temperature of the tank or of the gas present in said tank;

FIG. 12 illustrates the curves of FIG. 11 after reducing the “temperature” variable and reducing the “pressure” variable between zero (0) and one (1);

FIG. 13 illustrates an embodiment of a temperature variation curve of the gas in order to control filling of the tank and to prevent it from overheating;

FIG. 14 illustrates an embodiment of a temperature variation curve of the gas in combination with the reference temperature curve in order to control filling of the tank and to prevent it from overheating;

FIG. 15 shows an example of radial discretization of a tank wall;

FIG. 16 shows details of a mesh obtained after the discretization of FIG. 15.

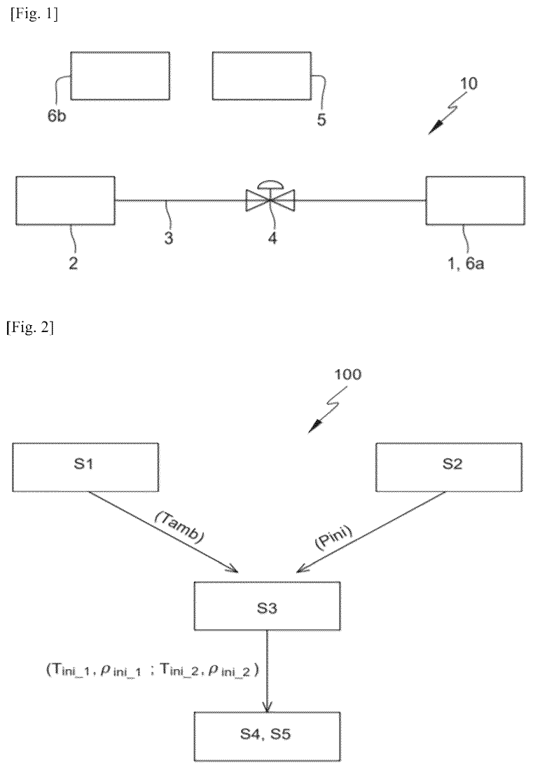

### DETAILED DESCRIPTION OF THE INVENTION

The device 10 for filling pressurized-gas tanks 1 is, for example, a station for filling pressurized-hydrogen tanks.

The device 10 comprises a gas source 2, a filling pipe 3 connecting the source 2 to the tank 1, a flow rate and/or pressure control valve 4 in the filling pipe 3, a set of one or more sensors 6a, 6bconfigured to measure the pressure in the tank 1 and/or the ambient temperature Tamb on the filling device 10.

Furthermore, the device 10 comprises an electronic control component 5 configured to control filling and notably to stop filling when an estimated temperature (respectively, a density) of the gas present in the tank 1 reaches a temperature limit value (respectively, a density limit value). The control component 5 is also configured to estimate an initial temperature of the gas present in the tank 1 before filling the tank 1.

The electronic control component 5 comprises, for example, a microprocessor, a computer or any suitable electronic controller.

According to the invention, the initial temperature Tini of the gas present in the tank 1 is a value that is estimated as a function of the ambient temperature Tamb and as a function of the pressure Pini of the gas present in the tank 1 before filling, with said initial temperature Tini being greater than or equal to or less than or equal to the ambient temperature Tamb.

Thus, for a given ambient temperature Tamb, the initial temperature Tini of the gas present in the tank is no longer a fixed quantity as provided by the prior art, but rather a quantity that depends on the initial pressure Pini of the gas present in the tank 1.

Advantageously, the initial temperature Tini of the gas present in the tank 1 is divided into a first computed initial temperature Tini_1 corresponding to a state of the tank 1 that is considered to be recently filled to a first initial density ρini_1, and a second computed initial temperature Tini_2 corresponding to a state of the tank 1 that is considered to be recently drawn off to a second initial density ρini_2.

The ambient temperature Tamb and the initial pressure Pini are respectively determined during a step S1 and a step S2 of a filling method implementing the filling device and schematically illustrated in FIG. 2. Steps S1 and S2 may or may not be carried out simultaneously. As for the initial temperature Tini, which is divided into a first initial temperature Tini_1 and a second initial temperature Tini_2, it is determined during a step S3 that is also illustrated in FIG. 2.

Hereafter, the tank 1 that is considered to have been recently filled will also be likened to a tank recently exposed to direct sunlight or in a relatively hot environment or even to a tank being hot-filled. In order to refill such a tank, the fluid that is already present is considered to have been compressed and therefore to have increased in temperature well beyond the ambient temperature.

The tank that is considered to have been recently drawn off will also be likened to a tank recently exposed to a relatively cold environment or to a tank being cold-filled. In order to fill such a tank, the residual fluid is considered to have previously experienced significant expansion and therefore significant cooling.

The tank that is considered to have been recently filled and the tank that is considered to have been recently drawn off are modeled virtual tanks that may or may not be identical. In the second case, the tank that is considered to have been recently drawn off notably can have a surface area: volume ratio that is greater than that of the tank that is considered to have been recently filled, which makes it more able to discharge the heat and to cool.

Advantageously, the first initial temperature Tini_1 of the gas present in the tank is within a high temperature range with a determined lower limit TLgas_min_1 that is greater than or equal to the ambient temperature and an upper limit TLgas_max_1 corresponding to a determined maximum temperature limit. The change in the lower limit TLgas_min_1 as a function of the ambient temperature of the filling device is provided by a curve “Thotsoak” (see FIG. 4) derived, for example, from recommendations of the SAE relating to filling a hot tank. The upper limit TLgasmax_1 is set, for example, to 85° C. This value takes into account the thermophysical properties of the tank.

Advantageously, the second initial temperature Tini_2 of the tank is within a low temperature range having a determined upper limit TLgas_max_2 that is less than or equal to the ambient temperature Tamb and a lower limit TLgas_min_2 corresponding to a determined minimum temperature limit, for example, ranging between zero and−5° C. In particular, the upper limit TLgas_max_2 is a function of the ambient temperature and follows a curve “Tcoldsoak” (see FIG. 4) derived, for example, from recommendations of the SAE relating to filling a cold tank.

Advantageously, the temperature limit value (respectively, the density limit value) is a determined fixed value or a value provided by a reference temperature curve “Tpgasmax” (respectively, a reference density curve). In particular, the reference temperature curve “Tpgasmax” (respectively, the reference density curve) allows, for a given pressure of the gas in the tank, the temperature limit value (respectively, the density limit value) to be estimated.

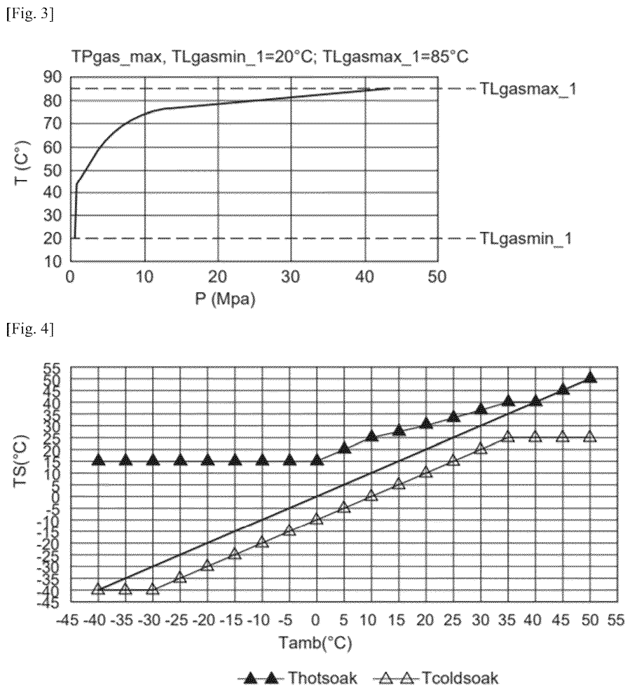

An example of a reference temperature curve “Tpgas_max” is illustrated in FIG. 3. For a maximum pressure of the gas present in the tank 1 the temperature limit value is 85° C. and coincides with the upper limit TLgasmax_1 of the high temperature range. For a minimum pressure of the gas in the tank, the temperature limit value is approximately 20° C. and coincides with the lower limit TLgasmin_1 of the high temperature range.

The density limit value depends on the service pressure of the tank. For example, for a service pressure of 350 barg, the density limit value is set to 24.1 kg/m3, for example. For a service pressure of 700 barg, the limit density value is set to 40.2 kg/m3, for example. In general, the density limit value can be defined by a state of filling “SOC” (“State of Charge”) percentage that defines a recommended maximum amount of hydrogen in a tank.

### Determining the Reference Temperature Curve “Tpgasmax” and the Reference Density Curve

Advantageously, the reference temperature curve “Tpgasmax” (respectively, the reference density curve) is provided by a first physical model that simulates a reference filling of the tank over the high temperature range (respectively, over the low temperature range) with pre-cooling at the source. The reference filling is simulated from a minimum pressure, which in this case is set to 5 barg, up to a maximum pressure corresponding to the service pressure of the tank.

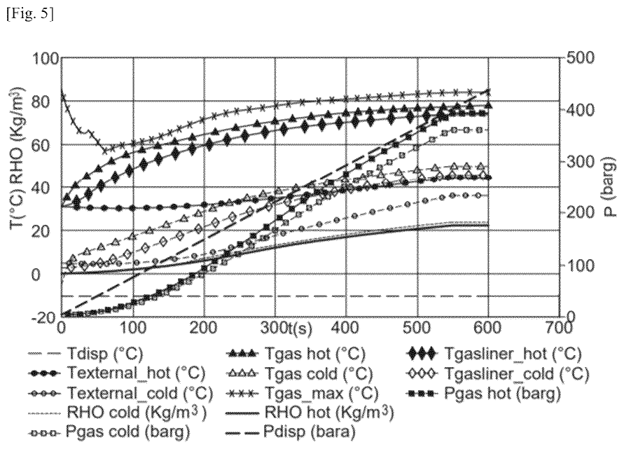

In particular, the reference temperature curve “Tpgasmax” (respectively, the reference density curve) is obtained from a curve “Pgashot” providing the change in the pressure of the gas present in the tank as a function of time and from a curve “Tgasmax” (respectively, a curve “RHO_cold”) providing the change in the temperature as a function of time (respectively, the change in the density) of the gas contained in the tank. The curves “Pgashot”, “Tgasmax” (respectively “RHO_cold”) are also provided by the first predetermined physical model. They are illustrated in FIG. 5.

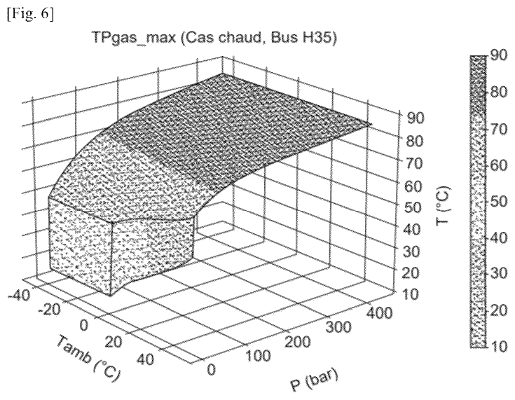

For various ambient temperatures, the first predetermined physical model provides as many reference temperature curves “Tpgasmax” (respectively, as many reference density curves) that form a reference temperature surface curve (respectively, a reference density surface curve). FIG. 6 illustrates an example of a reference temperature surface curve.

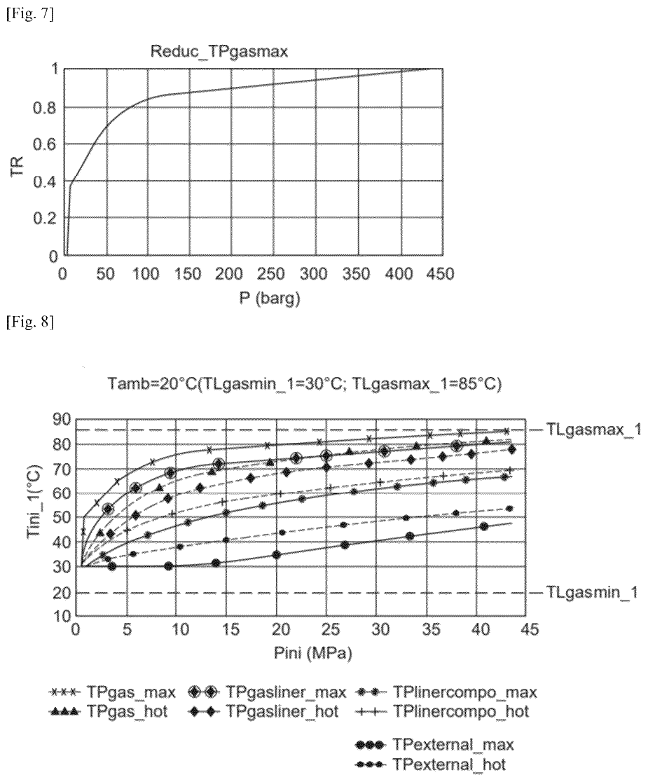

In order to facilitate the use of the reference temperature curve “Tpgasmax” (respectively, the reference density curve), the “temperature” variable is reduced between the value of zero (0) corresponding to the lower limit TLgasmin_1 and the value of one (1) corresponding to the upper limit TLgasmax_1. FIG. 7 illustrates a curve “Reduc_TPgasmax” obtained after reducing the “temperature” variable on the reference temperature curve “TPgasmax”.

### Determining the First Initial Temperature Tini_1 of the Gas

The first initial temperature Tini_1 of the gas present in the tank is provided by a second predetermined predictive curve “TPgashot” as a function of the initial pressure Pini of the gas (see FIG. 8). In other words, for a given initial pressure Pini of the gas present in the tank, the predictive curve “Tpgashot” allows the first initial temperature Tini_1 to be determined.

The predictive curve “Tpgashot” is drawn from a second physical model that simulates a reference filling of the tank over the high temperature range, optionally with pre-cooling of the gas supplied by the source. Preferably, the second physical model also simulates a thermal diffusion on the tank and/or on the gas present in the tank. Thus, the second physical model can differ from the first physical model by taking into account the thermal diffusion.

The thermal diffusion occurs after the reference filling of the tank and the pre-cooling of the source. Advantageously, the thermal diffusion is simulated over a period of 2 minutes, corresponding to the minimum time that is required between two successive fillings of the tank on the filling station. Still advantageously, during the thermal diffusion period, the pressure of the gas in the tank is assumed to be constant.

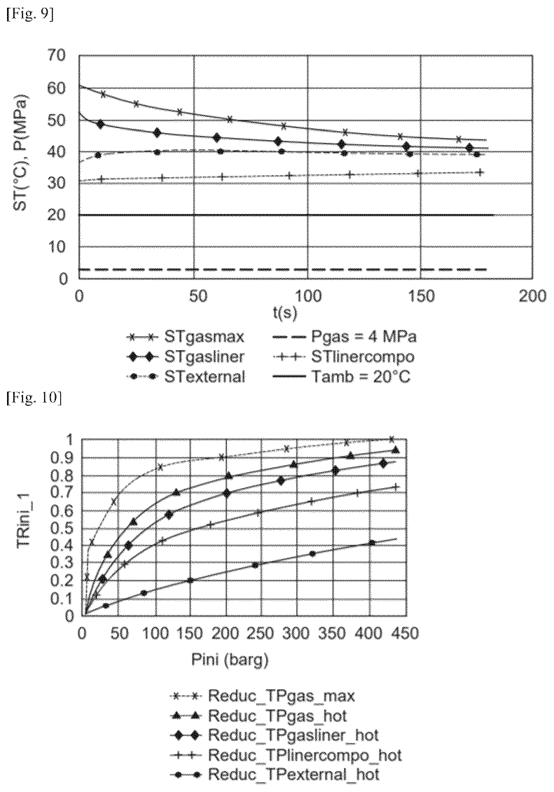

For a given ambient temperature, the thermal diffusion induces a temperature drop for the gas present in the tank. Such a drop is shown by a curve “Stgasmax” illustrated in FIG. 9.

It should be noted that the curve “Tpgashot” is obtained from the curve “Pgashot” and from the curve “Tgashot” that are both established for the same ambient temperature. In particular, the curve “Tgashot” results from a subtraction performed between the curve “Tgasmax” and the curve “STgasmax”.

Advantageously, in order to facilitate the use of the curve “TPgashot”, the “temperature” variable can be reduced between the value of zero (0) corresponding to the lower limit TLgasmin_1 and the value of one (1) corresponding to the upper limit TLgasmax_1. The curve “Reduc_TPgashot” thus obtained is illustrated in FIG. 10.

### Determining the Second Initial Temperature Tini_2 of the Gas

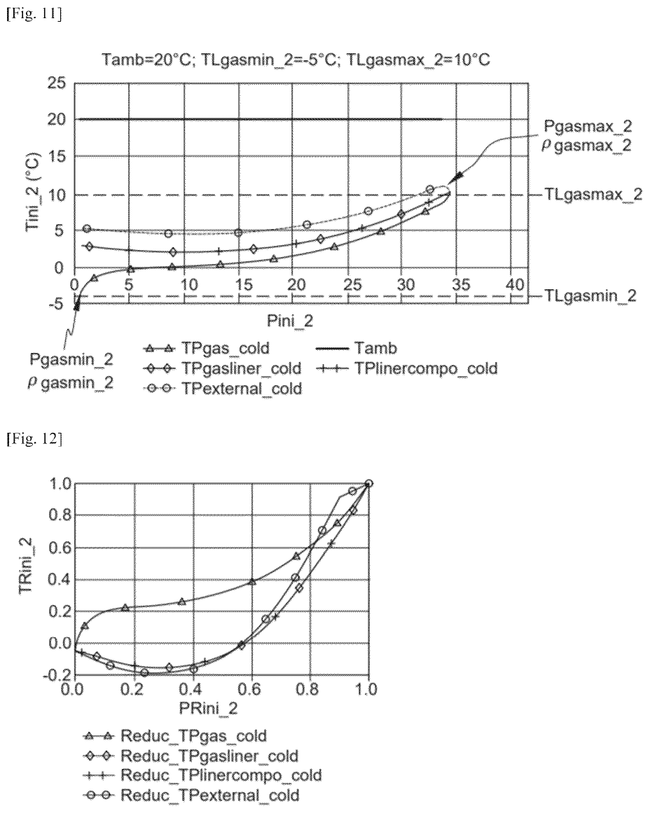

The second initial temperature Tini_2 of the gas is obtained from a third curve “TPgascold” as a function of the initial pressure Pini of the gas (see FIG. 11). In other words, based on the initial pressure Pini of the gas present in the tank, the curve “Tpgascold” allows the second initial temperature Tini_2 of the gas present in the tank to be determined.

The curve “TPgascold” can be provided by a third predetermined physical model (described below) that simulates a reference draining of the tank over the low temperature range, i.e., between the upper limit TLgasmax_2 and the lower limit TLgasmin_2.

The upper limit TLgasmax_2 corresponds to the start of the reference draining where the tank is in an at least partly filled state, and preferably is 100% filled. At this upper limit TLgasmax_2 there is a corresponding maximum pressure Pgasmax_2, called service pressure (“Nominal Working Pressure”), and a maximum density ρgasmax_2. It should be noted that the maximum pressure Pgasmax_2 can be written as a function of the upper limit TLgasmax_2 through the following mathematical expression taken from literature:

$$Pgasmax\_ 2 [ barg ] = A * TLgasmax\_ 2 [ °C . ] + B$$

with A ranging between 1 and 2, and B ranging between 300 and 400.

The lower limit TLgasmin_2 corresponds to the end of reference draining where the tank has a minimum pressure Pgasmin_2, in this case set to 5 barg, and a minimum density ρgasmin_2, called second initial density ρini_2. Furthermore, the lower limit TLgasmin_2 can be obtained from the following mathematical expression taken from the third physical model:

$$Tgasmin\_ 2 = A * Tamb + B$$

where

Tamb is the ambient temperature on the filling device;

A ranges between 0.5 and 1.5;

B ranges between −30 and −15.

For various ambient temperatures, the third physical model provides as many curves “Tpgascold” that form a surface curve (not illustrated). In order to facilitate the use of these curves “TPgascold”, the “temperature” variable on each of them is reduced between the value of zero (0) corresponding to the lower limit TLgasmin_2 and the value of one (1) corresponding to the upper limit TLgasmax_2. Similarly, the “pressure” variable can be reduced between the value of zero (0) corresponding to the minimum pressure Pgasmin_2 and the value of one (1) corresponding to the maximum pressure Pgasmax_2 before draining the tank. The curve “Reduc_TPgascold” illustrated in FIG. 12 is the result of such a reduction performed on the curve “TPgascold”.

Ultimately, for an initial pressure Pini measured in the tank and an ambient temperature Tamb taken from the filling device, at least one predetermined physical model considers that this initial pressure Pini is the final pressure of a previous filling (“hot case”) or of a previous draw-off (“cold case”). These two hypotheses respectively define a value for the first initial temperature Tini_1 (corresponding to the hot case) and a value for the second initial temperature Tini_2 (corresponding to the cold case). The value of the first initial temperature Tini_1 and the value of the second initial temperature Tini_2 thus defined can differ from the initial temperature value determined according to the prior art, for example, deviating by 10 to 20° C. from the ambient temperature.

### Estimating the Temperature Variation Curve of the Gas Between a First Temperature Variation Curve of the Gas (Hot Case) and a Second Temperature Variation Curve of the Gas (Cold Case)

Advantageously, the control component 5 can be configured to estimate, during filling, a temperature variation curve of the gas present in the tank as a function of the initial temperature of the gas present in the tank, i.e., with the initial temperature of the gas present in the tank as the starting point (or starting condition).

More specifically, the control component 5 can be configured to estimate such a curve between a first temperature variation curve of the gas (hot case) and a second temperature variation curve of the gas (cold case). Thus, for a given pressure of the gas present in the tank, the corresponding temperature is estimated between a first temperature located on the first temperature variation curve of the gas (hot case) and a second temperature located on the second temperature variation curve of the gas (cold case).

The first temperature variation curve (respectively, the second curve) of the gas has the first initial temperature Tini_1 (respectively, the second initial temperature Tini_2) of the gas as the starting point (or starting condition). Furthermore, the first temperature variation curve (respectively, the second curve) of the gas is supplied by a predetermined physical model that simulates reference filling of the tank from the first initial temperature Tini_1 (respectively, from the second initial temperature Tini_2) of the gas, with said filling being accompanied by pre-cooling at the source and followed by a thermal diffusion.

It should be noted that the physical model that is the source of the predictive curve “Tpgashot” of the first initial temperature Tini_1 of the gas is preferably the same as that which is the source of the first temperature variation curve of the gas. The two curves are distinguished by their starting points, which are respectively the lower limit TLgasmin_1 (for the predictive curve “TPgashot” of the first initial temperature Tini_1) and the first initial temperature Tini_1 (for the first temperature variation curve of the gas).

### Estimating the Density of the Gas Present in the Tank Between a First Density Variation Curve (Hot Case) and a Second Density Variation Curve (Cold Case)

Advantageously, the control component 5 can be configured to estimate (for example, compute), during filling, a density variation curve of the gas present in the tank as a function of the initial density of the gas present in the tank. This means that the density variation curve has the initial density of the gas present in the tank as the starting point. It should be noted that the initial density can be computed by the ideal or real gas equation while knowing the volume of the tank (known or estimated, for example, via the known technique based on a pressure pulse before filling), the pressure and the temperature of the gas.

More specifically, the control component 5 can be configured to estimate the density variation curve of the gas between a first density variation curve of the gas (hot case) and a second density variation curve of the gas (cold case). Thus, for a given pressure of the gas present in the tank, the corresponding density is estimated between a first density located on the first density variation curve (hot case) and a second density located on the second density variation curve (cold case).

The first density variation curve (respectively, the second curve) has the first initial density (respectively, the second initial density) of the gas present in the tank as the starting point.

Furthermore, the first density variation curve (respectively, the second curve) of the gas is provided by a physical model that simulates a reference filling of the tank from the first initial density (respectively, from the second initial density) of the gas with pre-cooling at the source.

### Determining the Reference Temperature Curve of the Tank and the Temperature Variation Curves of the Tank

Advantageously, the condition for stopping filling of the tank relating to a limit value of the temperature of the gas present in the tank can be replaced by a stop condition relating to a limit value of the temperature of the tank.

The limit value of the temperature of the tank can be provided by a reference temperature curve of the tank, with said curve being provided by the first physical model. In particular, for a tank formed by a plurality of layers, for example, an inner layer, called “liner” layer, in contact with the gas and an outer layer, called “composite” layer, in contact with the ambient air, the first physical model provides three reference temperature curves, illustrated in FIG. 8, namely, a first curve “TPgasliner_max” for the inner wall, a second curve “TPlinercompo_max” for the inner layer/outer layer interface, and a third curve “TPexternal_max” for the outer wall.

The curves “TPgasliner_max”, “TPexternal_max”, “TPlinercompo_max” can be obtained from the curve “Pgashot”, respectively in combination with the curves “Tgasliner_hot”, “Texternal_hot”, “Tlinercompo_hot” providing the change in the temperature as a function of time for the inner wall, the inner layer/outer layer interface, and the outer wall. The curves “Tgasliner_hot”, “Texternal_hot” are illustrated in FIG. 5.

Furthermore, in order to be easily used, the curves “TPgasliner_max”, “TPexternal_max”, “TPlinercompo_max” can be respectively converted into a curve “Reduc_TPgasliner_max”, a curve “Reduc_TPexternal_max”, and a curve “Reduc_TPlinercompo_max”, each defined between a value of zero (0) corresponding to the lower temperature limit TLgasmin_1 and a value of one (1) corresponding to the upper temperature limit TLgasmax_1.

### Estimating the Initial Temperature of the Tank Between a First Initial Temperature (Hot Case) and a Second Initial Temperature (Cold Case) of the Tank

The control component 5 can be configured to estimate the initial temperature of the tank between a first initial temperature of the tank corresponding to a state of the tank that is considered to be recently filled to the first initial density (hot case), and a second initial temperature of the tank corresponding to a state of the tank that is considered to be recently drawn off at a second initial density (cold case).

The first initial temperature Tini_1 of the tank can be provided by a predictive curve “TPgasliner_hot”, “TPlinercompo_hot”, “Tpexternal_hot” (see FIG. 8) as a function of the initial pressure Pini of the gas. In other words, for a given initial pressure Pini of the gas present in the tank, the predictive curve “TPgasliner_hot”, “TPlinercompo_hot”, “TPexternal_hot” allows the first initial temperature Tini_1 of the tank to be determined.

The curves “TPgasliner_hot”, “TPexternal_hot”, “Tplinercompo_hot” can be provided by the second physical model. More specifically, these curves are obtained from the curve “Pgashot”, respectively in combination with the curves “Tgasliner_hot_bis”, “Texternal_hot_bis”, “Tlinercompo_hot_bis” (not illustrated) providing the change in the temperature as a function of time, respectively for the inner wall, the outer wall and the inner layer/outer layer interface of the tank.

The curve “Tgasliner_hot_bis” is obtained from the curve “Tgasliner_hot” modulated by a curve “STgasliner”. The curve “Texternal_hot_bis” is obtained from the curve “Texternal_hot” modulated by a curve “STexternal”. The curve “Tlinercompo_hot_bis” is obtained from the curve “Tlinercompo_hot” modulated by a curve “STlinercompo”. The curves “STgasliner”, “STexternal”, “STlinercompo” are illustrated in FIG. 9. They represent a thermal diffusion after the reference filling and that occurs in the vicinity of the inner wall, the outer wall and the inner layer/outer layer interface of the tank.

In the example illustrated in FIG. 9, the thermal diffusion corresponds to a temperature drop over time for the inner wall of the tank. However, for the outer wall and the inner layer/outer layer interface of the tank, the thermal diffusion corresponds to an increase in temperature.

It should be noted that the curves “TPgasliner_hot”, “TPexternal_hot”, “TPlinercompo_hot” can be respectively reduced into a curve “Reduc_TPgasliner_hot”, a curve “Reduc_TPexternal_hot”, and a curve “Reduc_TPlinercompo_hot”, each defined between a value of zero (0) corresponding to the lower temperature limit Tlgas_min_1 and a value of one (1) corresponding to the upper temperature limit Tlgas_max_1 (see FIG. 10).

The second initial temperature Tini_2 of the tank is provided by a predictive curve “TPgasliner_cold”, “TPexternal_cold”, “TPlinercompo_cold” as a function of the initial pressure Pini of the gas (see FIG. 11). In other words, for a given initial pressure Pini of the gas, the predictive curve “TPgasliner_cold”, “TPexternal_cold”, “TPlinercompo_cold” allows the second initial temperature Tini_2 of the tank to be determined.

It should be noted that the predictive curve “TPgasliner_cold”, “TPexternal_cold”, “TPlinercompo_cold” can be provided by the third physical model that simulates a reference draining of the tank. On completion of this reference draining, the temperature of the tank reaches a minimum value that varies across the thickness of the tank. For a tank made up of two layers, the minimum temperature Tmin in the vicinity of the inner wall, the outer wall or the inner layer/outer layer interface can be provided, for example, by a linear law of the Tmin=A*Tamb+B type,

where

Tamb is the ambient temperature;

A ranges between 0.5 and 1.5;

B ranges between −20 and −10.

The predictive curves “TPgasliner_cold”, “TPexternal_cold”, “TPlinercompo_cold” can be obtained from the curve “Pgascold” (providing the change in the pressure of the gas as a function of time), respectively in combination with the curves “Tgasliner_cold”, “Texternal_cold”, “Tlinercompo_cold” providing the change in the temperature of the tank as a function of time (cold case). The curves “Tgasliner_cold”, “Texternal_cold” and “Pgas_cold” are illustrated in FIG. 5.

### Estimating the Temperature Variation Curve of the Tank Between a First Temperature Variation Curve of the Tank (Hot Case) and a Second Temperature Variation Curve of the Tank (Cold Case)

The control component 5 can be configured to estimate, during filling, a temperature variation curve of the tank (see step S5 of the method illustrated in FIG. 2). This estimate is made between a first temperature variation curve of the tank (hot case) and a second temperature variation curve of the tank (cold case). Said first curve and said second curve are determined during a step S4 of the method illustrated in FIG. 5.

The first variation curve has the first initial temperature Tini_1 of the tank as the starting point. The second variation curve has the second initial temperature Tini_2 of the tank as the starting point.

The first temperature variation curve (respectively, the second curve) of the tank can be obtained from a model that simulates a reference filling of the tank from the first initial temperature Tini_1 (respectively, from the second initial temperature Tini_2) of the tank, with pre-cooling of the gas at the source, and thermal diffusion after the reference filling.

### Effect of the Thermal Diffusion on the Predictive Curves of the First Initial Temperature Tini_1 of the Tank or of the Gas Present in the Tank

An analysis of FIG. 8, providing the reference temperature curves of the tank, or of the gas present in the tank, (i.e., the curves “TPgasliner_max”, “TPlinercompo_max”, “TPexternal_max”, “TPgas_max”), and the predictive curves of the first initial temperature Tini_1 of the tank, or of the gas in the tank, (i.e., the curves “TPgasliner_hot”, “TPlinercompo_hot”, “TPexternal_hot”, “TPgas_hot”), shows that the gas and the inner wall of the tank experience a reduction in their temperatures following the thermal diffusion, while the outer wall and the inner layer/outer layer interface of the tank experience an increase in their temperatures following the thermal diffusion.

Taking into account this singular change in the temperature of the tank following the thermal diffusion allows the accuracy of the reference temperature curve of the tank and/or the reference temperature curve of the gas present in the tank to be improved. Thus, the invention allows safety to be improved during filling by limiting the risk of exceeding the temperature limit value.

### Embodiments of the Reference Temperature Curve “Tgas_max” and of the First Temperature Variation Curve “Tgas_hot_bis” of the Gas

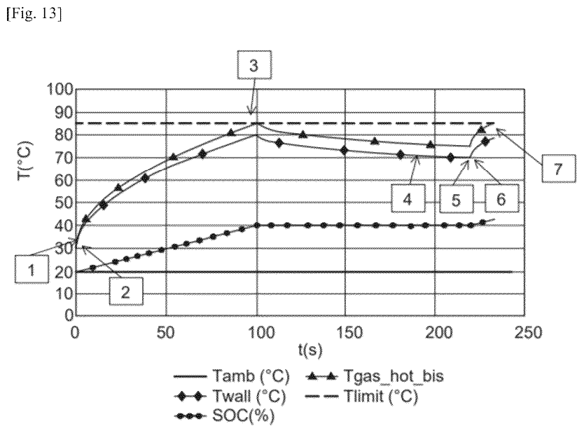

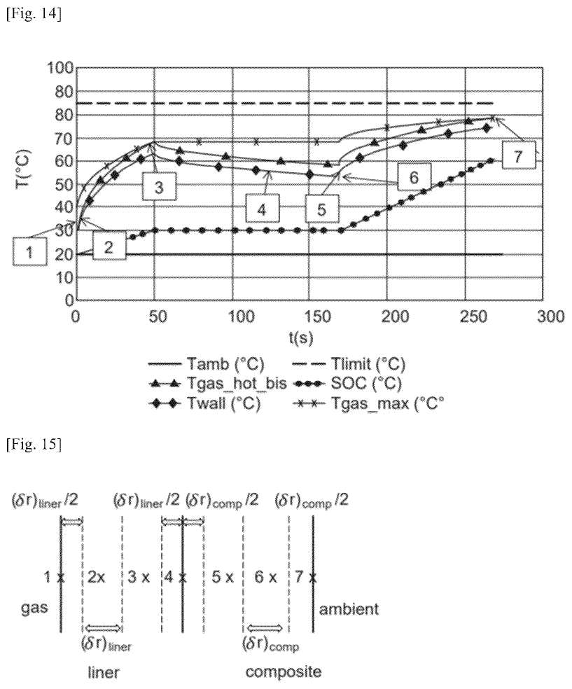

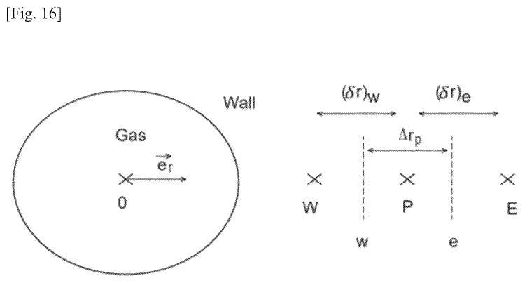

When filling the tank, in order to prevent any overheating, the first temperature variation curve “Tgas_hot_bis” of the gas present in the tank can be used alone (see the example of FIG. 13) or in combination with the reference temperature curve “Tgasmax” of the gas present in the tank (see the example of FIG. 14).

As shown in each of these examples, after connecting the vehicle to the end of the filling pipe (step 1) and initializing the filling by means of the filling device (step 2), initial overheating is detected in the gas present in the tank (step 3). In the example of FIG. 13, the overheating is detected when the curve “Tgas_hot_bis” reaches the temperature limit value that in this case is represented by a horizontal line at 85° C. In the example of FIG. 14, the initial overheating is detected below the temperature limit value (85° C.). This overheating corresponds to the moment when the curve “Tgas_hot_bis” “catches” the curve “Tgas_max”.

Following this initial overheating, the control component stops the filling while the tank is not filled to its maximum. The stop is extended (step 4) for a certain period of time that is required before a new filling cycle. Steps 5, 6, 7 correspond to this new filling cycle, for which the initial temperature of the gas present in the tank is determined as a function of the temperature reached by the same gas at the end of the preceding cycle, but also as a function of the pressure of this same gas at the beginning of the new cycle.

By taking into account the temperature reached during a previous filling cycle, then during a subsequent filling cycle the invention limits the risk of overheating, and opens the possibility of reaching a maximum load in the tank.

Of course, the curves “Tgas_max” and “Tgas_hot_bis” of the above examples can be replaced by the curves “TPgasmax” and “TPgas_hot” in order to control filling of the tank. When the stop condition relates to a limit value of the temperature of the tank, the filling can be controlled using one of the curves (hot case) providing the variation in the temperature of the tank (for example, the curve “TPgasliner_hot”). This variation curve can be used alone or in combination with the associated reference temperature curve, (for example, the curve “TPgasliner_max”).

### Presentation of the Physical Models

The aforementioned physical models that are the source of the various predictive curves presented in this description are based on a system of energy balance equations applied to the tank and to the gas present in the tank. These equations are presented below.
a. The internal energy balance equation of the gas in the tanks is written as follows:

$$\frac{d ( {m}_{g} {u}_{g} )}{dt} = {k}_{i} {S}_{i} ( {T}_{wi} - {T}_{g} ) + {Qh}_{g inlet} \qquad ( 1 )$$

This balance uses the mass of the gas in the tanks m_{g}, the mass internal energy of the gas in this tank u_{g}, the heat exchange between the gas in the tanks and the inner wall thereof with the exchange coefficient kᵢ and the inner surface of these tanks Sᵢ, the total hydrogen

$$Q = \frac{{dm}_{g}}{dt} ,$$

as well as the incoming mass enthalpy of the gas h_{g inlet} in the tanks. T_{g} and T_{wi} are respectively the spatial average temperatures of the gas in the volume of these tanks and of the inner wall thereof.

One of the two safety criteria not to be exceeded involves the density in the model. As the PLC can know the total volume of the tanks of the vehicle V_{CHSS} (Compressed Hydrogen Storage System), equation (1) can be written using m_{g}=V_{CHSS}ρ_{g}:

$${V}_{CHSS} \frac{d ( {ρ}_{g} {u}_{g} )}{dt} = {k}_{i} {S}_{i} ( {T}_{wi} - {T}_{g} ) + Q {h}_{g inlet} \qquad ( 2 )$$

In order to solve this equation (2), it needs to be discretized by replacing the time derivatives with finite differences. The equation is thus obtained, by dividing by V_{CHSS}:

$$\frac{{ρ}_{g} ( t + Δ t ) {u}_{g} ( t + Δ t ) - {ρ}_{g} ( t ) {u}_{g} ( t )}{Δ t} = {k}_{i} \frac{{S}_{i}}{{V}_{CHSS}} ( {T}_{wi} ( t + Δ t ) - {T}_{g} ( t + Δ t ) ) + \frac{Q}{{V}_{CHSS}} {h}_{g inlet} \qquad ( 3 )$$

where Δt is the value of a time step (approximately one second).

The material balance equation in the tanks is used to write:

$${V}_{CHSS} {ρ}_{g} ( t + Δ t ) = {V}_{CHSS} {ρ}_{g} ( t ) + Q \qquad ( 4 )$$

that is, by dividing by V_{CHSS}:

$${ρ}_{g} ( t + Δ t ) = {ρ}_{g} ( t ) + \frac{Q}{{V}_{CHSS}} \qquad ( 5 )$$

Equation (5) allows the value of ρ_{g}(t+Δt) to be obtained. Equation (3) therefore allows the value of the internal energy u_{g}(t+Δt) to be obtained:

$${u}_{g} ( t + Δ t ) = \frac{{k}_{i} \frac{{S}_{i}}{{V}_{CHSS}} ( {T}_{wi} ( t + Δ t ) - {T}_{g} ( t ) ) Δ t + \frac{Q}{{V}_{CHSS}} {h}_{g inlet} Δ t + {ρ}_{g} ( t ) {u}_{g} ( t )}{{ρ}_{g} ( t + Δ t )} \qquad ( 6 )$$

b. The energy conservation equation in the wall is written as follows:

$$ρ {c}_{p} \frac{\partial T}{\partial t} = \frac{λ}{r} \frac{\partial }{\partial r} ( \frac{\partial T}{\partial r} ) \qquad ( 7 )$$

This balance involves the density of the wall ρ, its heat capacity v and its thermal conductivity λ, as well as the radius r from the center of the tank.

At the interface between the gas and the liner, the flow continuity equation is written as follows:

$${k}_{i} {S}_{i} ( {T}_{g} - {T}_{wi} ) = - {\int }_{{S}_{i}} {λ}_{liner} \frac{\partial T}{\partial r} dS \qquad ( 8 )$$

At the interface between the composite and the ambient environment, the flow continuity equation is written as follows:

$$- {\int }_{{S}_{e}} {λ}_{comp} \frac{\partial T}{\partial r} dS = {k}_{e} {S}_{e} ( {T}_{we} - {T}_{amb} ) \qquad ( 9 )$$

where kₑ is the heat exchange coefficient between the ambient environment and the outer wall of the tank, Sₑ is the outer surface of these tanks and T_{amb} is the ambient temperature.

Finally, at the interface between the two liner and composite materials inside the wall, the flow continuity equation is written as follows:

$$- {{λ}_{liner} ( \frac{\partial T}{\partial r} )}_{liner} = - {{λ}_{comp} ( \frac{\partial T}{\partial r} )}_{comp} s \qquad ( 10 )$$

c. Discretization of the equations in the wall.

In order to solve equations (7), (8), (9) and (10), the wall needs to be radially discretized into various meshes. The number of meshes in the liner n_liner and in the composite n_comp can vary. The wall temperatures are computed on each node, and then n_mesh=n_liner+n_comp+1 nodes. Therefore, the size of the meshes is (δr)ₗᵢₙₑᵣ=eₗᵢₙₑᵣ/nₗᵢₙₑᵣ in the liner and (δr)_{comp}=e_{comp}/n_{comp} in the composite, as shown in FIG. 13. The thickness of the meshes at the interfaces is (δr)/2. In the illustrated example, 3 meshes are provided in the liner and 3 other meshes are provided in the composite.

Equation (7) is discretized and applied for each of the various meshes forming the wall so that it can be solved. FIG. 14 shows the radial discretization used to solve the equation. In this figure, a mesh, centered on the point P, is surrounded by a point W to the west and by a point E to the east, with the inside of the tank being located to the west. A fictitious face w is defined between the points W and P, and a second fictitious face e is defined between the points P and E. The distances between points W and P, on the one hand, and P and E, on the other hand, are respectively denoted (δr)^{w} and (δr)^{e}. The faces w and e are separated by Δrₚ. Points W, P and E are respectively located at r_{W}, r_{P} and r_{E} from the center of the tank.

Equation (7) is integrated over a time step and is spatially integrated from west to east, in order to obtain:

$$A = {\int }_{w}^{e} {\int }_{t}^{t + Δ t} ( ρ {c}_{p} \frac{\partial T}{\partial t} ) r dr dt = {\int }_{t}^{t + Δ t} {\int }_{w}^{e} [ \frac{\partial }{\partial r} ( λ r \frac{\partial T}{\partial r} ) ] dr dt = B \qquad ( 11 )$$

The left term is called A, while the right term is called B.

Assuming that the density ρ and the thermal capacity cₚ hardly change between the instants t and t+Δt, the left term is written as follows:

$$A = {\int }_{w}^{e} {\int }_{t}^{t + Δ t} ( ρ {c}_{p} \frac{\partial T}{\partial t} ) r dr dt ≃ {\int }_{w}^{e} ρ {c}_{p} ( {\int }_{t}^{t + Δ t} \frac{\partial T}{\partial t} dt ) r dr = {\int }_{w}^{e} ρ {c}_{p} [ T ( r , t + Δ t ) - T ( r , t ) ] r dr \qquad ( 12 )$$

It is assumed that the temperature difference T(r, t+Δt)−T(r,t) remains constant between points w and e and is equal to T(rₚ, t+Δt)−T(rₚ,t). The term A is written as follows:

$$A ≃ ρ {c}_{p} \frac{T ( {r}_{P} , t + Δ t ) - T ( {r}_{P} , t )}{Δ t} {\int }_{w}^{e} rdr \qquad ( 13 )$$

By writing:

$${\int }_{w}^{e} rdr = ( \frac{{r}_{E}^{2} - {r}_{W}^{2}}{2} ) = ( {r}_{E} - {r}_{W} ) ( \frac{{r}_{E} + {r}_{W}}{2} ) = Δ {r}_{p} ( \frac{{r}_{E} + {r}_{W}}{2} ) ,$$

the term A is ultimately written as follows:

$$A ≃ ρ {c}_{p} \frac{T ( {r}_{P} , t + Δ t ) - T ( {r}_{P} , t )}{Δ t} Δ {r}_{P} ( \frac{{r}_{E} + {r}_{W}}{2} ) \qquad ( 14 )$$

The term B, namely, the right term of equation (11), can be written as follows:

$$B = {\int }_{t}^{t + Δ t} [ λ ( {r}_{E} , t ) {r}_{E} \frac{\partial T}{\partial r} ( {r}_{E} , t ) - λ ( {r}_{W} , t ) {r}_{W} \frac{\partial T}{\partial r} ( {r}_{W} , t ) ] dt \qquad ( 15 )$$

By assuming that

$$\frac{\partial T}{\partial r} ( {r}_{E} , t ) = \frac{T ( {r}_{E} , t ) - T ( {r}_{P} , t )}{{( δ r )}_{e}} and \frac{\partial T}{\partial r} ( {r}_{W} , t ) = \frac{T ( {r}_{P} , t ) - T ( {r}_{W} , t )}{{( δ r )}_{w}} ,$$

and by assuming that the thermal conductivity λ hardly changes between the instants t and t+Δt, the term B is written as follows:

$$B = λ ( {r}_{E} , t ) {r}_{E} {\int }_{t}^{t + Δ t} \frac{T ( {r}_{E} , t ) - T ( {r}_{P} , t )}{{( δ r )}_{e}} dt - λ ( {r}_{W} , t ) {r}_{W} {\int }_{t}^{t + Δ t} \frac{T ( {r}_{P} , t ) - T ( {r}_{W} , t )}{{( δ r )}_{w}} dt \qquad ( 16 )$$

The values taken at the instant t are noted with an exponent ⁰ , and the values taken at the instant t +Δt are noted with an exponent ¹. The values taken at points W, P and E, respectively, are noted with an index _{W, P} and _{E}. For example, the value T(rₚ, t+Δt) is noted

$${T}_{p}^{1} .$$

An implicit scheme is used, and therefore equation (11) becomes:

$${ρ}^{0} {c}_{p}^{0} \frac{{T}_{P}^{1} - {T}_{P}^{0}}{Δ t} Δ {r}_{P} ( \frac{{r}_{E} + {r}_{W}}{2} ) = {λ}_{E}^{0} {r}_{E} \frac{{T}_{E}^{1} - {T}_{P}^{1}}{{( δ r )}_{e}} - {λ}_{W}^{0} {r}_{W} \frac{{T}_{P}^{1} - {T}_{W}^{1}}{{( δ r )}_{w}} \qquad ( 17 )$$

At the interface between the gas and the liner, the flow continuity equation (8) is discretized as follows:

$${k}_{i}^{0} {S}_{i} ( {T}_{g}^{0} - {T}_{1}^{1} ) = - {λ}_{l i n e r}^{0} {S}_{i} \frac{{T}_{2}^{1} - {T}_{1}^{1}}{{( δ r )}_{l i n e r}} \qquad ( 18 )$$

At the interface between the composite and the ambient environment, the flow continuity equation (9) is discretized as follows:

$$- {λ}_{c o m p}^{0} {S}_{e} \frac{{T}_{{n}_{m e s h}}^{1} - {T}_{{n}_{m e s {h}^{- 1}}}^{1}}{{( δ r )}_{c o m p}} = {k}_{e}^{0} {S}_{e} ( {T}_{{n}_{m e s h}}^{1} - {T}_{a m b}^{1} ) \qquad ( 19 )$$

Finally, at the interface between the two liner and composite materials inside the wall, the flow continuity equation (10) is discretized as follows:

$$- {λ}_{l i n e r}^{0} \frac{{T}_{{n}_{l i n e {r}^{+ 1}}}^{1} - {T}_{{n}_{l i n e r}}^{1}}{{( δ r )}_{l i n e r}} = - {λ}_{c o m p}^{0} \frac{{T}_{{n}_{l i n e {r}^{+ 2}}}^{1} - {T}_{{n}_{l i n e {r}^{+ 1}}}^{1}}{{( δ r )}_{c o m p}} \qquad ( 20 )$$

The system of equations (17) for each point P that is not located at an interface and (18), (19) and (20) can be solved by the Thomas algorithm, also called TDMA (Tri-Diagonal Matrix Algorithm).

### Physical Properties and Coefficients

a. Tg and Pg from ρ and u

For each time step, the model computes the temperature and the pressure of the gas based on the density ρ and the internal energy u of the gas:

$${T}_{g} = {f}_{1} ( ρ , u ) \qquad ( 21 )$$

$${P}_{g} = {f}_{2} ( ρ , u ) \qquad ( 22 )$$

These functions f₁ and f₂ are adjusted in order to best correspond to the thermophysical properties of the gas.
b. Heat transfer coefficients kᵢ and kₑ

The model also needs values for the heat transfer coefficients kᵢ and kₑ. For the internal transfer coefficient kᵢ, a function is used that is calibrated based on the correlation presented by Bourgeois, T. et al., (see “Bourgeois T., Ammouri F., Weber M., Knapik C., ‘Evaluating the temperature inside a tank during a filling with highly-pressurized gas’. International Journal of Hydrogen Energy 2015; 40: 11748-55”).

$$N {u}_{Dint} = \frac{{D}_{i n t} {k}_{i}}{{λ}_{g}} = a \cdot {Ra}_{Dint}^{b} + c \cdot {Re}_{dinj}^{d} \qquad ( 23 )$$

For the external transfer coefficient kₑ, a function is used that is calibrated based on the correlation presented by Massard, F. (see heat engineer's checklist. ELSEVIER; 1997):

$${k}_{e} = 0.675 {λ}_{a i r} \frac{R {a}_{D e x t}^{0.058}}{Dext} , R {a}_{Dext} < 1 {0}^{- 2} \qquad ( 24.1 )$$

$${k}_{e} = 1.02 {λ}_{a i r} \frac{R {a}_{D e x t}^{0.148}}{Dext} , 1 {0}^{- 2} < R {a}_{Dext} < 1 {0}^{2} \qquad ( 24.2 )$$

$${k}_{e} = 0.85 {λ}_{a i r} \frac{R {a}_{D e x t}^{0.188}}{Dext} , 1 {0}^{2} < R {a}_{Dext} < 1 {0}^{4} \qquad ( 24.3 )$$

$${k}_{e} = 0.48 {λ}_{a i r} \frac{R {a}_{D e x t}^{0.25}}{Dext} , 1 {0}^{4} < R {a}_{Dext} < 1 {0}^{8} \qquad ( 24.4 )$$

$${k}_{e} = 0.125 {λ}_{a i r} \frac{R {a}_{D e x t}^{0333}}{Dext} , 1 {0}^{8} < R {a}_{Dext} \qquad ( 24.5 )$$

Advantageously, the physical models described above can be associated with a heat transfer model between the filling device and the one or more tanks. This transfer model is described below.

The term of incoming mass enthalpy of the gas h_{g inlet} of equation (1) is obtained based on the mass enthalpy of the gas on the dispenser by virtue of a heat transfer model. Its aim is to estimate the heat exchanges of the gas between the dispenser of the filling device and the inlet into the tanks of the vehicle, along the length of the hose and the other elements connecting the dispenser to the tanks.

The energy conservation equation applied to the gas inside the piping is written in equation (25), for each elementary length dx along the piping. In this case, it is assumed that the piping has a homogeneous temperature over its entire length:

$$\dot{m} {c}_{p , g} \frac{d {T}_{gas , pipe}}{d x} = {k}_{i , pipe} ( t ) π {d}_{int , pipe} ( {T}_{pipe} ( t ) - {T}_{gas , pipe} ( x , t ) ) \qquad ( 25 )$$

where m is the gas density, c_{p,g} is the mass thermal capacity of the gas, x is the abscissa along the piping, T_{gas,pipe} is the temperature of the gas in the piping depending on x and t, k_{i,pipe} is the internal exchange coefficient in the piping, d_{int,pipe} is the average internal diameter of the piping and Tₚᵢₚₑ is the temperature of the piping solely depending on t.

Equation (25) can be integrated between 0 (the dispenser) and the position x along the piping in order to obtain the expression of T_{gas,pipe}(x, t). For the sake of greater clarity, L_{C}(t)=\dot{m}c_{p,g}/(k_{i,pipe}(t)πd_{int,pipe}) is noted as a characteristic length:

$$d {T}_{gas , pipe} / ( {T}_{pipe} ( t ) - {T}_{gas , pipe} ( x , t ) ) = 1 / {L}_{C} ( t ) dx \qquad ( 26.1 )$$

$${[ - ln ( {T}_{pipe} ( t ) - {T}_{gas , pipe} ( x , t ) ) ]}_{0}^{x} = 1 / {{L}_{C} ( t ) [ x ]}_{0}^{x} \qquad ( 26.2 )$$

$$( {T}_{pipe} ( t ) - {T}_{gas , pipe} ( x , t ) ) / ( {T}_{pipe} ( t ) - {T}_{disp} ) = exp ( - x / {L}_{C} ( t ) ) \qquad ( 26. 3 )$$

The energy conservation equation applied to the piping is written in equation (27):

$${( m {c}_{p} )}_{pipe} \frac{d {T}_{pipe}}{dt} = \dot{m} Δ {h}_{pipe} ( t ) - {k}_{e , pipe} ( t ) {S}_{e , pipe} ( {T}_{pipe} ( t ) - {T}_{a m b} ( t ) ) \qquad ( 27 )$$

where (mcₚ) pipe is the heat capacity of the piping, Δhₚᵢₚₑ is the energy transferred from the gas to the piping, k_{e,pipe} is the external exchange coefficient of the piping and S_{e,pipe} is the external surface of the piping.

The term \dot{m}Δhₚᵢₚₑ(t), by virtue of equation (26.3), can be written as follows:

$$\dot{m} Δ {h}_{pipe} ( t ) = - {\int }_{0}^{L} {k}_{i , pipe} ( t ) π {d}_{int , pipe} ( {T}_{pipe} ( t ) - {T}_{gas , pipe} ( x , t ) ) dx \qquad ( 28.1 )$$

$$\dot{m} Δ {h}_{pipe} ( t ) = - {k}_{i , pipe} ( t ) π {d}_{int , pipe} {\int }_{0}^{L} ( {T}_{pipe} ( t ) - {T}_{disp} ) exp ( - x / {L}_{C} ( t ) ) dx \qquad ( 28.2 )$$

$$\dot{m} Δ {h}_{pipe} ( t ) = \dot{m} {c}_{p , g} ( {T}_{pipe} ( t ) - {T}_{disp} ) [ exp ( - {L}_{pipe} / {L}_{C} ( t ) ) - 1 ] \qquad ( 28.3 )$$

where Lₚᵢₚₑ is the length of the piping.

Equation (27) is discretized:

$${T}_{pipe} ( t + Δ t ) = {T}_{pipe} ( t ) + \frac{Δ t}{{( m {c}_{p} )}_{pipe}} [ \dot{m} Δ {h}_{pipe} ( t ) - {k}_{e , pipe} ( t ) {S}_{e , pipe} ( {T}_{pipe} ( t ) - {T}_{amb} ) ] \qquad ( 29 )$$

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1-16. (canceled)

17. A method for filling a pressurized-gas tank, the method comprising the steps of:
providing a filling device comprising:
a gas source,
a filling pipe connecting the source to the tank,
a flow rate and/or pressure control valve in the filling pipe, and
an electronic control component configured to stop filling when an estimated temperature or density of the gas present in the tank reaches a temperature or density limit value,
determining an ambient temperature on the filling device,
determining a pressure of the gas present in the tank and
estimating an initial temperature of the gas present in the tank, wherein the initial temperature of the gas present in the tank is a value that is estimated as a function of the ambient temperature and as a function of the pressure of the gas present in the tank before filling, with said initial temperature of the gas present in the tank being greater than or equal to or less than or equal to the ambient temperature; and
filling the pressurized-gas tank.

18. The method as claimed in claim 17, wherein the initial temperature of the gas present in the tank is divided into a first computed initial temperature corresponding to a state of the tank that is considered to be recently filled to a first initial density, and a second computed initial temperature corresponding to a state of the tank that is considered to be recently drawn off to a second initial density.

19. The method as claimed in claim 18, wherein the first computed initial temperature of the gas present in the tank is within a high temperature range with a lower limit that is determined to be greater than or equal to the ambient temperature and an upper limit corresponding to a determined maximum temperature limit, for example, equal to 85° C.

20. The method as claimed in claim 18, wherein the first computed initial temperature is determined from a first predetermined predictive curve provided by a predetermined physical model simulating a reference filling of the tank over the high temperature range.

21. The method as claimed in claim 18, wherein the second computed initial temperature of the gas present in the tank is within a low temperature range with an upper limit that is determined to be less than or equal to the ambient temperature and a lower limit corresponding to a determined minimum temperature limit, for example, ranging between zero and −5° C.

22. The method as claimed in claim 18, wherein the second computed initial temperature is determined from a second predetermined predictive curve provided by a predetermined physical model simulating a reference draining of the tank over the low temperature range.

23. The method as claimed in claim 18, further comprising: modeling, during filling,
a first temperature variation curve or a first density variation curve of the gas present in the tank, wherein when the first temperature variation curve is modeled, having the first computed initial temperature of the gas present in the tank as the starting condition, wherein when the first density variation curve is modeled, having the first initial density, wherein when the second temperature variation curve is modeled, having the second computed initial temperature of the gas present in the tank as the starting condition, wherein when the second density variation curve is modeled, having the second initial density of the gas present in the tank as the starting condition.

24. The method as claimed in claim 23, further comprising a step of estimating, during filling:
a temperature variation curve of the gas present in the tank, with said temperature variation curve ranging between the first temperature variation curve and the second temperature variation curve, or
a density variation curve of the gas present in the tank, with said density variation curve ranging between the first density variation curve and the second density variation curve.

25. The method as claimed in claim 18, wherein the first computed initial temperature and/or the second computed initial temperature is recomputed during filling as a function of the flow rate and as a function of the temperature of the gas present in the filling pipe, with said flow rate and said temperature being determined by computation and/or by sensors on the filling device.

26. The method as claimed in claim 17, wherein the temperature limit value is a determined fixed value, or a value provided by a reference temperature curve, with said reference temperature curve being provided by a predetermined physical model that simulates the thermodynamic conditions of the gas during a reference filling of the tank,
wherein the density limit value is a determined fixed value or a value provided by a reference density curve, with said reference density curve being provided by a predetermined physical model that simulates the thermodynamic conditions of the gas during a reference filling of the tank.

27. The method as claimed in claim 20, wherein the physical model is based on a system of equations comprising at least one from among:
an internal energy balance equation applied to the gas present in the tank;
a mass balance equation applied to the gas present in the tank;
an energy conservation equation in a tank wall;
a heat flow continuity equation between the gas present in the tank and the tank wall;
a heat flow continuity equation between the tank wall and the ambient air; and
a flow rate equation connecting a mass flow rate of the filling device to a pressure difference between the filling device and the tank.

28. The method as claimed in claim 27, wherein the first or second computed initial temperature and the initial pressure of the gas present in the tank are obtained by solving said system of equations.

29. The method as claimed in claim 17, wherein the ambient temperature of the filling device and the initial pressure of the gas present in the tank are determined by computation and/or are measured by sensors on the filling device.

30. The method as claimed in claim 17, wherein the electronic control component is configured to control the flow rate and/or pressure control valve in order to generate a predetermined pressure curve or ramp during filling.

31. The method as claimed in claim 23, wherein the electronic control component is configured to simulate and estimate the temperature variation curve and/or the density variation curve of the gas present in the tank in a dynamic manner when filling the tank and/or in an anticipated manner before filling.

32. A device for filling a pressurized-gas tank, the device comprising:
a gas source,
a filling pipe connecting the source to the tank,
a flow rate and/or pressure control valve in the filling pipe,
a set of one or more sensors configured to measure the pressure in the tank and/or the ambient temperature on the filling device, and
an electronic control component configured to perform the steps of:
stop filling when an estimated temperature or density of the gas present in the tank reaches a temperature limit value or density limit value; and
estimate, before filling the tank, an initial temperature of the gas present in the tank,
wherein the initial temperature of the gas present in the tank is a value that is estimated as a function of the ambient temperature and as a function of the pressure of the gas present in the tank before filling, with the initial temperature of the gas present in the tank being greater than or equal to or less than or equal to the ambient temperature.
